(19) United States
(12) Patent Application Publication
(10) Pub. No.: US 2012/0285726 A1
(43) Pub. Date: Nov. 15, 2012

(54) ELECTRICALLY CONDUCTIVE ELEMENT, PHOTOSENSITIVE MATERIAL FOR FORMATION OF ELECTRICALLY CONDUCTIVE ELEMENT, AND ELECTRODE

(75) Inventors: Tsukasa Tokunaga, Kanagawa (JP); Akira Ichiki, Kanagawa (JP)

(73) Assignee: FUJIFILM CORPORATION, Minato-ku, Tokyo (JP)

(21) Appl. No.: 13/522,970

(22) PCT Filed: Jan. 20, 2011
(86) PCT No.: PCT/JP2011/051017

§ 371 Date: Jul. 19, 2012

(30) Foreign Application Priority Data
Jan. 20, 2010 (JP) 2010-010276

(51) Int. Cl. H01B 5/00

(52) U.S. Cl. 174/126.2; 174/126.1

(57) ABSTRACT

Disclosed are: an electrically conductive element having high electrical conductivity; a photosensitive material for formation of an electrically conductive element, which is suitable for producing the electrically conductive element; and an electrode. The electrically conductive element comprises: a support; a metal pattern layer comprising an electrically conductive metal; and an electrically conductive microparticle-containing layer comprising needle-shaped electrically conductive microparticles having an average long axis length of from 0.2 μm to 20 μm, an average short axis length of from 0.01 μm to 0.02 μm, and an aspect ratio of 20 or more, a binder, and a sucrose fatty acid ester.

### TECHNICAL FIELD

The present invention relates to an electrically conductive element, a photosensitive material for forming an electrically conductive element and electrode.

### BACKGROUND ART

In recent years, electrically conductive elements obtained by various production methods have been investigated. One of these electrically conductive elements is an electrically conductive element produced by using a photosensitive material for forming an electrically conductive element, which has a silver salt-containing layer, such as a silver halide emulsion layer, on a support. This photosensitive material is exposed pattern-wise in a mesh-like form, and then subjected to a developing treatment, so as to produce an electrically conductive element having an electrically conductive region, which is a mesh including developed silver, and an opening region for ensuring transparency (see, for example, Japanese Patent Application Laid-Open (JP-A) Nos. 2004-221564 and 2007-95408). Further, as other electrically conductive elements, those produced by using electrically conductive fiber are also known (see, for example, JP-A Nos. 2009-277466 and 2009-116452).

However, when these electrically conductive elements are used as various kinds of electrodes such as an electrode of an electromagnetic wave shielding film, an organic EL element (here, the term “EL” is an abbreviation for “electroluminescence”), or an inorganic EL element, or an electrode of an electrochromic element, these elements are found to be insufficient in electrical conductivity.

### DISCLOSURE OF INVENTION

### Technical Problem

An object of the present invention is to provide an electrically conductive element having a high electrical conductivity.

Another object of the present invention is to provide a photosensitive material for forming an electrically conductive element, which is suitable for producing an electrically conductive element having a high electrical conductivity.

Yet another object of the present invention is to provide an electrode having a high electrical conductivity.

Yet another object of the present invention is to provide a method for producing an electrically conductive element having a high electrical conductivity.

### Solution to Problem

As a result of eagerly conducting investigations in order to attain the above objects, the present inventors have found that, when using granular electrically conductive microparticles, durability over a long period of time is insufficient. Further, in the case of an electrically conductive element containing electrically conductive microparticles in the form of needles, aggregation occurs easily and productivity is deteriorated.

Further, the present inventors have found that, by using a sucrose fatty acid ester in combination with needle-like electrically conductive microparticles, the aggregation of electrically conductive microparticles can be sufficiently suppressed, and further, durability against a long period of use can be enhanced, thereby completing the present invention.

Namely, in a first embodiment, the present invention provides an electrically conductive element having a first support, a metal pattern layer including an electrically conductive metal, and an electrically conductive microparticle-containing layer which contains needle-shaped electrically conductive microparticles having an average long axis length of from 0.2 μm to 20 μm, an average short axis length of from 0.01 μm to 0.02 μm, and an aspect ratio of 20 or more, a binder, and a sucrose fatty acid ester.

In a second embodiment, the present invention provides an electrically conductive element having a support and an electrically conductive microparticle-containing layer which contains needle-like electrically conductive microparticles, a binder, and a sucrose fatty acid ester.

In a third embodiment, the present invention provides a photosensitive material for forming an electrically conductive element, the photosensitive material having a support, a silver salt-containing layer, and an electrically conductive microparticle-containing layer which contains needle-shaped electrically conductive microparticles, a binder, and a sucrose fatty acid ester.

Further, in a fourth embodiment, the present invention provides an electrode having a metal pattern layer including an electrically conductive metal, an electrically conductive microparticle-containing layer which contains needle-like electrically conductive microparticles, a binder, and a sucrose fatty acid ester, and an electric current-passing layer disposed adjacent to the electrically conductive microparticle-containing layer.

Furthermore, in a fifth embodiment, the present invention provides a method for producing an electrically conductive element, the method including preparing an electrically conductive element having a metal pattern layer, which includes a metallic silver, and the above-described electrically conductive microparticle-containing layer by exposing patternwise the above photosensitive material for forming an electrically conductive element and then subjecting the exposed material to a developing treatment.

In the present invention, in any of the above embodiments, it is preferable that the content ratio of the sucrose fatty acid ester/the needle-like electrically conductive microparticles is from 10% by mass to 50% by mass, and that the content of the sucrose fatty acid ester contained in the electrically conductive microparticle-containing layer is 0.5 g/m² or less. Further, it is preferable that the electrically conductive microparticles contain at least one kind of metal oxides selected from the group consisting of SnO₂, ZnO, TiO₂, Al₂O₃, In₂O₃, MgO, BaO, and MoO₃, a composite metal oxide thereof, or a metal oxide in which a differen atom is incorporated into these metal oxides; and it is particularly preferable that the electrically conductive microparticles contain SnO₂ doped with antimony, and that the content of the electrically conductive microparticles contained in the electrically conductive microparticle-containing layer is from 0.05 g/m² to 0.99 g/m².

### Advantageous Effects of Invention

According to the present invention, an electrically conductive element having a high electrical conductivity and a method for producing the same, and a photosensitive material for forming an electrically conductive element, which is suitable for obtaining the electrically conductive element may be provided.

### BEST MODE FOR CARRYING OUT THE INVENTION

The present invention is an electrically conductive element having a support, a metal pattern layer including an electrically conductive metal, and an electrically conductive microparticle-containing layer which contains needle-like electrically conductive microparticles having an average long axis length of from 0.2 μm to 20 μm, an average short axis length of from 0.01 μm to 0.02 μm, and an aspect ratio of 20 or more, a binder, and a sucrose fatty acid ester.

Further, the present invention also includes an electrically conductive element having a support and an electrically conductive microparticle-containing layer which contains needle-like electrically conductive microparticles, a binder, and a sucrose fatty acid ester; and a photosensitive material for forming an electrically conductive element, the photosensitive material having a support, a silver salt-containing layer, and an electrically conductive microparticle-containing layer which contains needle-like electrically conductive microparticles, a binder, and a sucrose fatty acid ester.

Hereinafter, each of the materials used for the electrically conductive element of the present invention is described. In this specification, a numerical range described by using the term “to” represents a range including numerical values described in front of and behind “to”, as the minimum value and the maximum value.

[Support]

Examples of a support which may be employed for the electrically conductive element of the present invention include a plastic film, a plastic plate, and a glass plate.

The support is preferably a plastic film or plastic plate having a melting point of about 290° C. or lower, such as polyethylene terephthalate (PET) (melting point: 258° C.), polyethylene naphthalate (PEN) (melting point: 269° C.), polyethylene (PE) (melting point: 135° C.), polypropylene (PP) (melting point: 163° C.), polystyrene (melting point: 230° C.), polyvinyl chloride (melting point: 180° C.), polyvinylidene chloride (melting point: 212° C.), or triacetylcellulose (TAC) (melting point: 290° C.). PET is particularly preferable from the viewpoints of light transmittance, workability, and the like.

The thickness of the support is selected from a range of from 10 μm to 200 μm, and is more preferably selected from a range of from 70 μm to 180 μm.

It is preferable that the support has high transparency. The entire visible transmittance of the support is preferably 70% or more, more preferably 85% or more, and particularly preferably 90% or more.

Further, a colored support may also be employed.

[Metal Pattern Layer]

The metal pattern layer used in the electrically conductive element of the present invention includes an electrically conductive metal as a component thereof. Any metal can be used as the electrically conductive metal as long as the metal exhibits electrical conductivity. As the electrically conductive metal, copper, aluminum, silver, and the like are preferable, since they have excellent electrical conductivity.

The electrically conductive metal may be composed of a single metal, or may be an alloy. Further, the metal that constitutes the metal pattern may have a laminate structure of two or more kinds of metals, in a case in which the electrically conductive element is viewed from a cross sectional face perpendicular to the plane of the electrically conductive element.

The metal pattern layer is constituted of fine lines, and the pattern form includes mesh, stripe, and the like. The line width of the fine line (namely, the maximum length in the direction parallel to the plane of the electrically conductive element in a cross section of a face perpendicular to the direction along which the fine line stretches) is preferably 30 μm or less, and more preferably from 0.5 μm to 20 μm. Further, the line thickness of the fine line (namely, the maximum length in the direction perpendicular to the above line width) is generally selected from a range of from 0.1 μm to 5 μm, and is more preferably selected from a range of from 1 μm to 3 μm. It is preferable that the line thickness of the fine line is greater, from the viewpoint of improvement in electrical conductivity.

The metal pattern layer may be formed by, for example, the method described in the following (1) to (4).

(1) A method for forming a metal pattern layer by exposing pattern-wise a photosensitive material, which has, on a support, an emulsion layer containing photosensitive silver halide and then subjecting the exposed material to a developing treatment, thereby forming a metallic silver portion and a light-transmitting portion, each corresponding to the pattern, at the exposed portion and the unexposed portion, respectively. Further, an electrically conductive metal may be disposed on the metallic silver portion by subjecting the metallic silver portion to a physical development and/or a plating treatment.

(2) A method for forming a metal pattern layer by exposing a photo-resist membrane on a copper foil formed on a support, followed by performing developing treatment to form a resist pattern, and then etching the copper foil which is not covered with the resist pattern.

(3) A method for forming a metal pattern layer by printing a pattern of a paste (containing a catalyst), which contains metal microparticles on a support and then subjecting the printed paste to a metal plating.

(4) A method for forming a metal pattern layer on a support by printing using a screen printing plate or a gravure printing plate. In the case of forming a metal pattern layer by printing, first, a catalyst layer (containing a catalyst) that corresponds to the metal pattern layer is formed, and then metal plating is performed to the catalyst layer, whereby a metal pattern layer can be formed, and the electrical conductivity can be improved.

[Electrically Conductive Microparticle-Containing Layer]

For the electrically conductive microparticles used in the electrically conductive microparticle-containing layer, needle-shaped electrically conductive microparticles are used. The needle-like electrically conductive microparticles preferably have a short axis length of from 0.01 μm to 0.02 μm and an aspect ratio of the long axis and the short axis of 10 or more. More specifically, the needle-shaped electrically conductive microparticles preferably have an average long axis length of from 0.2 μm to 20 μm and an average short axis length of from 0.01 μm to 0.02 μm. The aspect ratio of the long axis and the short axis is preferably of 20 or more, more preferably from 20 to 2000, and still more preferably from 20 to 50. The powder resistivity is preferably from 3 Ωcm to 1000 Ωcm, and more preferably from 100 Ωcm to 600 Ωcm.

The average long axis length, average short axis length and the aspect ratio of the needle-shaped electrically conductive microparticles can be calculated from volume-surface mean diameter measured by an image analyzer.

By using the needle-shaped electrically conductive microparticles, in the case of preparing an electrode structure such as an EL element or the like, durability is enhanced, and light can be emitted for a long time at a constant luminance. The present inventors consider that the needle-shaped electrically conductive microparticles are likely to form a network and this is useful for the improvement in durability.

Meanwhile, in the case of using needle-shaped electrically conductive microparticles, aggregation easily occurs, and productivity may easily be deteriorated; however, by using a sucrose fatty acid ester in combination, the aggregation can be sufficiently suppressed, and the productivity can be improved. This effect becomes more remarkable, in a case in which the volume ratio of the electrically conductive microparticles/the binder is high, namely, in a case in which the content of the electrically conductive microparticles is high.

Examples of the electrically conductive microparticles may include microparticles containing a compound selected from the group consisting of metal oxides such as SnO₂, ZnO, TiO₂, Al₂O₃, In₂O₃, MgO, BaO, or MoO₃, composite oxides thereof, and metal oxides in which a different atom is incorporated into these metal oxides. An example of the other atom is antimony. Two or more kinds of these electrically conductive microparticles may be used in combination.

As for the electrically conductive microparticles, microparticles containing SnO₂, ZnO, TiO₂, Al₂O₃, In₂O₃, or MgO are preferable from the viewpoint of electrical conductivity, and microparticles containing SnO₂ are more preferable. Particularly, microparticles containing SnO₂ doped with antimony are still more preferable from the viewpoint of electrical conductivity, and microparticles containing SnO₂ doped with from 0.2 mol % to 2.0 mol % of antimony are most preferable.

As the electrically conductive microparticles having the above characteristics, FS series (trade name) manufactured by ISHIHARA SANGYO KAISHA, LTD., and electrically conductive materials manufactured by Mitsubishi Materials Electronic Chemicals Co., Ltd. can be used. Particularly, FS-10D (trade name) manufactured by ISHIHARA SANGYO KAISHA, LTD. is preferable.

[Sucrose Fatty Acid Ester]

The electrically conductive microparticle-containing layer contains a sucrose fatty acid ester as a surfactant. The sucrose fatty acid ester is preferably contained in such an amount that the content ratio of the sucrose fatty acid ester/the needle-like electrically conductive microparticles is from 10% by mass to 50% by mass, and more preferably from 10% by mass to 30% by mass.

As the content ratio becomes lower than 10% by mass, aggregation of the needle-like electrically conductive microparticles may occur more easily, and in the case of being employed as an electrode of an EL element, defects may appear at the display section.

Meanwhile as the content ratio exceeds 50% by mass, the surface resistivity of the electrically conductive element may become lower. The reason for this is guessed that, when the amount of the sucrose fatty acid ester which adheres to the needle-like electrically conductive microparticles becomes too large, the electrical conductivity would be damaged.

Further, the content of the sucrose fatty acid ester contained in the electrically conductive microparticle-containing layer is preferably 0.5 g/m² or less, and more preferably 0.3 g/m² or less. As the content exceeds 0.5 g/m², the surface resistivity of the electrically conductive element becomes lower. In the case of forming the electrically conductive microparticle-containing layer by a method including preparing, as a coating liquid, a solvent solution by dissolving or dispersing the components which constitute the electrically conductive microparticle-containing layer, then coating the coating liquid on a support, and then removing the solvent by evaporation, the concentration of the sucrose fatty acid ester in the coating liquid is preferably 20% by mass or less, and more preferably 10% by mass or less.

Examples of the sucrose fatty acid ester include sucrose monofatty acid ester, sucrose difatty acid ester, and sucrose trifatty acid ester; among them sucrose monofatty acid ester is more preferable; and as to the fatty acid portion, lauric acid, palmitic acid, stearic acid, and oleic acid are preferable. That is, sucrose fatty acid esters in which the sugar residue is sucrose and the alkyl group or alkenyl group of the fatty acid portion is a lauryl group, a myristyl group, a palmityl group, a stearyl group, an oleyl group, or the like are preferable. Specifically, as the sucrose monofatty acid ester, sucrose monolaurate and sucrose monostearate are preferable, and sucrose monolaurate is particularly preferable. These sucrose fatty acid esters are commercially available from Wako Pure Chemical Industries, Ltd.

[Binder for Electrically Conductive Microparticle-Containing Layer]

In the electrically conductive element of the present invention, it is preferable that the amount of the binder in the electrically conductive microparticle-containing layer is smaller, and it is preferable that the amount of the binder is 1 g/m² or less. The amount of the binder in the electrically conductive microparticle-containing layer is preferably 0.5 g/m² or less, and more preferably 0.1 g/m² or less. Thus, an electrically conductive element having a high electrical conductivity can be obtained.

The binder contained in the electrically conductive microparticle-containing layer is preferably selected from those having functions of not only homogeneously dispersing the electrically conductive microparticles in the electrically conductive microparticle-containing layer but also making a conductive layer adhere to the surface of the support. Regarding such a binder, either a non-water-soluble polymer or a water-soluble polymer can be used as the binder, but it is preferable to use a water-soluble polymer.

Specific examples of the water-soluble polymer include gelatin, polyvinyl alcohol (PVA), polyvinyl pyrrolidone (PVP), polysaccharides such as starch, cellulose and derivatives thereof, polyethylene oxide, polysaccharide, polyvinyl amine, chitosan, polylysine, polyacrylic acid, polyalginic acid, polyhyaluronic acid, and carboxycellulose. These polymers have a neutral, anionic, or cationic property depending on the ionicity of the functional group. The gelatin may be a chemically modified gelatin, and examples include gelatins subjected to acetylation, deamination, benzoylation, dinitrophenylation, trinitrophenylation, carbamylation, phenylcarbamylation, succinylation, succinylation, phthalation, or the like. Among them, the case of using phthalated gelatin is preferred. In the case of using phthalated gelatin, improved electrical conductivity and improved state of coated surface can be achieved at the same time. In the present invention, gelatin is particularly preferable as the binder.

The electrically conductive microparticle-containing layer can further contain latex, in addition to the surfactant. Preferable examples of such latex may include polymer latexes of polylactates, polyurethanes, polycarbonates, polyesters, polyacetals, SBRs, polyvinyl chlorides, or the like. Further, polymer latexes described in JP-A No. 2009-79166 may be used alone or in combination. In the exemplary embodiment of the present invention, the latex is particularly preferably a polymer latex containing polymer particles formed from acrylic acid ester-styrene copolymer or styrene-butadiene copolymer.

(Protective Layer/Adhesion Imparting Layer)

The electrically conductive element of the present invention may further include a protective layer/adhesion imparting layer, on the electrically conductive microparticle-containing layer. This protective layer/adhesion imparting layer contains a binder which is used in the electrically conductive microparticle-containing layer. This layer may also contain latex similar to the electrically conductive microparticle-containing layer, and polymer latex containing polymer particles formed from acrylic acid ester-styrene copolymer or styrene-butadiene copolymer is particularly preferable.

It is preferable to provide the electrically conductive microparticle-containing layer such that the amount of the electrically conductive microparticles falls within a range of from 0.05 g/m² to 0.99 g/m², from the viewpoints of electrical conductivity and transparency. The above lower limit is more preferably 0.1 g/m², still more preferably 0.2 g/m², and particularly preferably 0.3 g/m². The above upper limit is preferably 0.5 g/m².

It is preferable that the metal pattern layer and the electrically conductive microparticle-containing layer are disposed adjacent to each other such that electrons may flow between the electrically conductive metal that constitutes the metal pattern and the electrically conductive microparticles. The order of these layers is not limited, but preferably, the metal pattern layer and the electrically conductive microparticle-containing layer are disposed in this order from the side nearer to the support.

An undercoat layer may be disposed between the support and the metal pattern layer or the electrically conductive microparticle-containing layer, with the intension of ensuring sufficient adhesive force between the support and the layer, and the like. Further, a protective layer may be disposed on the surface of the electrically conductive element at the side of the support having a metal pattern layer and an electrically conductive microparticle-containing layer, with the intention of preventing damages of the electrically conductive microparticle-containing layer, and the like.

Furthermore, a back layer may be disposed on a surface of a side of the support opposite from the side formed thereon a metal pattern layer. The back layer prevents the electrically conductive element from being curved or curled, and provides an electrically conductive element having excellent planarity. Further, in the case of integrating the electrically conductive element of the present invention, for example, as an electrode of an inorganic EL, an organic EL, or the like, the back layer may be formed so as to have a function of an adhesive layer.

In the case of having an undercoat layer between the support and a layer disposed on the support and adjacent to the support, the undercoat layer is set so as to be a layer including a polymer binder as a constituent component.

In the case of having a protective layer as the layer farthest from the support, the protective layer is set so as to be a layer including a polymer binder as a constituent component.

Examples of the polymer binder used in the undercoat layer or the protective layer may include the above-described binder used in the electrically conductive microparticle-containing layer.

In a case in which the electrically conductive element has a protective layer, it is preferable that the protective layer contains silica. The content of silica is preferably 0.16 g/m² or more, and more preferably 0.24 g/m² or more. The content of silica is preferably 0.5 g/m² or less, and more preferably 0.4 g/m² or less.

It is preferable to use a colloid-like silica (colloidal silica) as the silica.

Colloidal silica means a colloid of silicic anhydride microparticles having an average particle diameter of from 1 nm to 1 μm; and for the colloidal silica, description in JP-A No. 53-112732, Japanese Patent Application Publication (JP-B) Nos. 57-009051 and 57-51653, and the like can be referred to. Although the colloidal silica may be prepared by the sol-gel method and these can be used, commercially available products can also be utilized.

In the case of using a commercially available product, SNOWTEX-XL (average particle diameter of from 40 nm to 60 nm), SNOWTEX-YL (average particle diameter of from 50 nm to 80 nm), SNOWTEX-ZL (average particle diameter of from 70 nm to 100 nm), PST-2 (average particle diameter of 210 nm), MP-3020 (average particle diameter of 328 nm), SNOWTEX 20 (average particle diameter of from 10 nm to 20 nm, SiO₂/Na₂O>57), SNOWTEX 30 (average particle diameter of from 10 nm to 20 nm, SiO₂/Na₂O>50), SNOWTEX C (average particle diameter of from 10 nm to 20 nm, SiO₂/Na₂O>100), and SNOWTEX O (average particle diameter of from 10 nm to 20 nm, SiO₂/Na₂O>500) and the like can be preferably used (these products are all trade names, manufactured by Nissan Chemical Industries, Ltd.; here, the SiO₂/Na₂O represents the content ratio by mass of silicon dioxide with respect to sodium hydroxide in terms of Na₂O, and the values of which are listed in a catalog). In the case of utilizing the commercially available product, SNOWTEX-YL, SNOWTEX-ZL, PST-2, MP-3020, and SNOWTEX C are particularly preferable.

Moreover, as the colloidal silica, a colloidal silica having a long and thin form with a thickness of from 1 nm to 50 nm and a length of from 10 nm to 1000 nm as described in JP-A No. 10-268464, and composite particles of colloidal silica and an organic polymer as described in JP-A Nos. 9-218488 and 10-111544 can also be used preferably.

In a case in which the metal pattern layer has a square opening, it is preferable that the opening is formed so as to satisfy the following equations (a) and (b), wherein X (unit: μm) represents the width of the opening (one side of the square) and Y (unit: Ω/□) represents the surface resistivity of the opening.

50≦X≦7000 Equation (a)

10⁵≦Y≦(5×10²³)×X^{-4.02} Equation (b)

The opening is more preferably formed such that Y satisfies the following equation (b1), and still more preferably formed such that Y satisfies the following equation (b2).

10⁵≦Y≦1×10²³×(X)^{-4.02} Equation (b1)

10⁵≦Y≦3×10²²×(X)^{-4.25} Equation (b2)

In the case of using the electrically conductive element as a transparent electrode, a line width D of the mesh is preferably as narrow as possible in order to ensure high transparency. Generally, the line width D of the mesh is preferably 30 μm or less, more preferably 20 μm or less, and still more preferably 15 μm or less. The line width is preferably 0.5 μm or more, and more preferably 3 μm or more. For example, in a straight line lattice pattern, the ratio of the line width D/the width X of the opening, namely, the line/space is preferably from 5/995 to 10/595.

In the present invention, the width X of the opening of the metal mesh is from 50 μm to 7,000 μm, more preferably from 100 μm to 5,000 μm, and even more preferably from 200 μm to 2,000 μm.

The electrically conductive element of the present invention is preferably produced by a production method (a) including subjecting a photosensitive material for forming an electrically conductive element, the photosensitive material having a support, a silver salt-containing layer, and an electrically conductive microparticle-containing layer which contains needle-shaped electrically conductive microparticles, a binder, and a sucrose fatty acid ester, to a pattern exposure and a developing treatment, or by a production method (b) including: subjecting a photosensitive material for forming an electrically conductive element, the photosensitive material having a support and a silver salt-containing layer to a pattern exposure and a developing treatment to prepare an electrically conductive element precursor having a support and a metal pattern layer containing a metal pattern composed of metallic silver formed through the development; and then forming, on the metal pattern layer, an electrically conductive microparticle-containing layer which contains needle-like electrically conductive microparticles, a binder, and a sucrose fatty acid ester. It should be noted that the metal pattern layers formed by any of the methods described in (2) to (4) which are described above in the paragraph of [Metal pattern layer] may also be used in place of the electrically conductive element precursor in the production method (b).

Hereinafter, these production methods are explained.

As described above, in the above production method (a), a photosensitive material (a) for forming an electrically conductive element, the photosensitive material having a support, a silver salt-containing layer, and an electrically conductive microparticle-containing layer which contains needle-shaped electrically conductive microparticles, a binder, and a sucrose fatty acid ester (hereinafter, may also be referred to as a “photosensitive material (a)”), is used. Meanwhile, in the above production method (b), a photosensitive material (b) for forming an electrically conductive element, the photosensitive material having a support and a silver salt-containing layer (hereinafter, may also be referred to as a “photosensitive material (b)”), is used.

In both the photosensitive material (a) and the photosensitive material (b), as the support, those explained for the support of the electrically conductive element described above may be used.

<Silver Salt-Containing Layer>

The silver salt contained in the silver salt-containing layer which is used in the photosensitive material (a) and the photosensitive material (b) may be an inorganic silver salt such as silver halide or an organic silver salt such as silver acetate. In the present invention, silver halide having excellent characteristics as a photosensor is preferably used.

The silver halide preferably used in the present invention is explained.

In the present invention, it is preferable to use silver halide having excellent characteristics as a photosensor, and the silver halide is used as a silver halide emulsion in which silver halide in the form of grains is contained and dispersed in a binder which serves as a protective colloid. Techniques used for silver salt photographic films relating to silver halide emulsion, printing paper, films for printing plate making, emulsion masks for photomasks, or the like can also be used in the present invention.

A halogen element contained in the silver halide may be any of chlorine, bromine, iodine, or fluorine, or these elements may be used in combination.

<Binder>

In the silver halide emulsion layer (silver salt-containing layer), a binder may be used to disperse the silver salt grains homogeneously and to aid the adhesion between the emulsion layer and the support. In the present invention, either a non-water-soluble polymer or a water-soluble polymer may be used as the binder, but it is preferable that the proportion of a water-soluble binder, which is to be removed by the below-described treatment of immersing in hot water or contacting with vapor, is large.

Examples of the binder include gelatin, carrageenan, polyvinyl alcohol (PVA), polyvinyl pyrrolidone (PVP), polysaccharides such as starch, cellulose and derivatives thereof, polyethylene oxide, polysaccharide, polyvinyl amine, chitosan, polylysine, polyacrylic acid, polyalginic acid, polyhyaluronic acid, and carboxycellulose. These materials have a neutral, anionic, or cationic property depending on the ionicity of the functional group.

Preferably, gelatin is used. As for the gelatin, acid-processed gelatin as well as lime-processed gelatin may be used, and a hydrolysis product of gelatin, a enzyme-decomposed product of gelatin, or others (phthalated gelatin or acetylated gelatin obtained by modifying the amino group or the carboxyl group) can be used, but for the gelatin used in the silver salt preparing process, it is preferable to use a gelatin in which the positive charged amino group is changed to an uncharged or negative charged group, and it is more preferable to use phthalated gelatin.

The content of the binder contained in the emulsion layer is not particularly limited, and can be appropriately determined within the range in which the dispersibility of silver halide and the adhesion of the photosensitive layer can be exerted. From the viewpoint of the electrically conductive element, it is preferable that the amount of the binder in the emulsion layer is small. From these viewpoints, the ratio of the volume of silver halide in terms of silver/the volume of binder (hereinafter, may be referred to as the “volume ratio of silver/binder”) is preferably 1/2 or more, and more preferably 1/1 or more. The upper limit of the volume ratio of silver/binder is preferably 4/1, and more preferably 3/1.

<Solvent>

Although the solvent used for the formation of the emulsion layer is not particularly limited, examples thereof may include water, an organic solvent (for example, an alcohol such as methanol, a ketone such as acetone, an amide such as formamide, a sulfoxide such as dimethyl sulfoxide, an ester such as ethyl acetate, an ionic liquid, and a mixture thereof. The content of the solvent used in the emulsion layer according to the present invention is in a range of from 30% by mass to 90% by mass, and preferably from 50% by mass to 80% by mass, with respect to the total mass of the silver salt, the binder, and the like contained in the emulsion layer.

The emulsion layer preferably contains an antifoggant. The antifoggant is preferably selected from nitrogen atom-containing heterocyclic compounds, and among them, indazoles, imidazoles, benzimidazoles, triazoles, benzotriazoles, tetrazoles, and triazaindolizines are preferable. These compounds are preferable in view of suppressing the occurrence of black spots at the opening of the electrically conductive element, and preventing reduction in the electrical conductivity of the electrically conductive element associated with the addition of the antifoggant. The addition amount of the antifoggant is preferably in a range of from 3 mg/m² to 15 mg/m², and more preferably in a range of from 6 mg/m² to 13 mg/m², from the viewpoints of reducing the quantity of occurrence of black spots, and suppressing a rise in the surface resistivity of the electrically conductive element. The content of the antifoggant by mole is preferably in a range of from 0.02 mmol/m² to 0.13 mmol/m², and more preferably in a range of from 0.06 mmol/m² to 0.11 mmol/m².

The silver salt-containing layer may contain, other than the above compounds, various additives which may be conventionally added to photographic silver halide emulsions, for example, a dye, a polymer latex, a hardener, a hard gradation agent, a toning agent, an electrically conducting agent, or the like.

It is preferable to provide, on the support, the photosensitive layer of the photosensitive material for forming an electrically conductive element of the present invention such that the amount of silver salt in terms of silver is from 5 g/m² to 30 g/m², and more preferably in a range of from 7 g/m² to 15 g/m².

Further, the thickness of the photosensitive layer is preferably in a range of from 1 μm to 20 μm, and more preferably in a range of from 1 μm to 10 μm.

In a case in which the electrically conductive element of the present invention is produced by the production method (b) described above, a photosensitive material (b) having a support and a silver salt-containing layer is used; but in a case in which the electrically conductive element of the present invention is produced by the production method (a) described above, a photosensitive material (a) further having, on the silver salt-containing layer, an electrically conductive microparticle-containing layer which contains needle-like electrically conductive microparticles, a binder, and a sucrose fatty acid ester is used. With regard to the composition and thickness of the electrically conductive microparticle-containing layer, the contents explained above for the electrically conductive element may be applied. The photosensitive material (a) and the photosensitive material (b) may have an undercoat layer between the support and the photosensitive layer. In the case of the photosensitive material (a), a protective layer may be further provided on the electrically conductive microparticle-containing layer. Further, in the case of the photosensitive material (b), a protective layer may be provided on the silver salt-containing layer.

(Method for Producing Electrically Conductive Element)

A production method (a) for producing the electrically conductive element of the present invention, using the above photosensitive material (a) for forming an electrically conductive element; and a production method (b) for producing the electrically conductive element of the present invention, using the above photosensitive material (b) for forming an electrically conductive element are explained. In the explanation below, a mesh-like pattern is explained as the pattern of the metal pattern, but also the same explanation can be applied to the cases of other patterns.

(Production Method (a) of Electrically Conductive Element>

In the production method (a) of the electrically conductive element, first, the photosensitive material (a) having a support, a silver salt-containing layer, and an electrically conductive microparticle-containing layer which contains needle-shaped electrically conductive microparticles, a binder, and a sucrose fatty acid ester is subjected to a pattern exposure in a mesh-like pattern, and then subjected to a developing treatment. Here, the term “developing treatment” encompasses a developing process of reducing silver halide grains, which have a latent image speck formed by exposure, to obtain silver, and a fixing process of dissolving and removing silver halide grains in which a latent image speck has not been formed.

(Exposure)

Exposure is performed in a pattern form such as a mesh. As described above, the form of the mesh may be a desired form, for example, a square, a rectangle, a triangle, a hexagon, or the like.

Pattern exposure may be performed by planar exposure utilizing a photomask, or may be performed by scanning exposure with a laser beam. In this process, a refractive exposure employing a lens or a reflective exposure employing a reflecting mirror may be adopted, and an exposure system such as a contact exposure, a proximity exposure, a reduced projection exposure, or a reflective projection exposure can be employed.

(Developing Treatment)

The photosensitive material (a) that has been subjected to pattern exposure in a mesh form is then subjected to a developing treatment. The developing treatment can be performed using ordinary techniques of developing treatment which are used for silver salt photographic films, printing paper, films for printing plate making, emulsion masks for photomasks, or the like. Although the developing solution is not particularly limited, a PQ developing solution, an MQ developing solution, an MAA developing solution, or the like can also be used. As commercially available products, for example, developing solutions such as CN-16, CR-56, CP45X, FD-3, or PAPITOL (all trade names, manufactured by Fujifilm Corporation), or C-41, E-6, RA-4, DSD-19, or D-72 (all trade names, manufactured by KODAK), or developing solutions contained in kits thereof can be used. Further, a lith developing solution can also be used. As the lith developing solution, for example, D85 (trade name) manufactured by KODAK or the like can be used.

The developing treatment in the production method (a) of the present invention can include a fixing process which is performed for the purpose of removing a silver salt from an unexposed area for stabilization. In the production method of the present invention, the fixing process can be performed using the techniques of fixing treatment which are used for silver salt photographic films, printing paper, films for printing plate making, emulsion masks for photomasks, or the like.

The developing solution used in the developing treatment may contain an image quality improver for the purpose of improving image quality. Examples of the image quality improver may include nitrogen-containing heterocyclic compounds such as benzotriazole. Further, in the case of utilizing a lith developing solution, it is also particularly preferable to use polyethylene glycol.

The mass of the metallic silver contained in the exposed area after the developing treatment is preferably 50% by mass or more, and more preferably 80% by mass or more, in terms of content ratio, with respect to the mass of silver contained in the exposed area before the exposure. When the mass of the silver contained in the exposed area is 50% by mass or more with respect to the mass of silver contained in the exposed area before the exposure, high electrical conductivity can be easily obtained, which is preferable.

The metallic silver portion contained in the exposed area after the developing treatment is composed of silver and a non-conductive polymer, wherein the volume ratio of the silver/the non-conductive polymer is preferably 2/1 or more, and more preferably 3/1 or more.

Although the gradation after the developing treatment is not particularly limited, it is preferable to exceed 4.0. When the gradation after the developing treatment exceeds 4.0, the electrical conductivity of the electrically conductive metal portion can be enhanced while maintaining high transparency of the light-transmitting portion. Examples of a means for enhancing the gradation to 4.0 or more include a means for hard gradation that is achieved by doping silver halide grains with a rhodium ion or an iridium ion during preparation of the silver halide emulsion.

In the present invention, it is preferable that the developing temperature, the fixing temperature, and the water washing temperature are performed at 25° C. or lower. When a smoothing treatment or a de-binder treatment is performed, as necessary, subsequent to the developing treatment, a film having higher electrical conductivity can be obtained.

In the present invention, by performing the above-described patternwise exposure and developing treatment, a mesh including developed silver is formed at the exposed area, and an opening region is formed at the unexposed area. Further, an electrically conductive microparticle-containing layer which contains needle-like electrically conductive microparticles, a binder, and a sucrose fatty acid ester, is disposed on the metallic silver mesh layer thus formed, and thus the electrically conductive element of the present invention is obtained.

(Production Method (b) of Electrically Conductive Element)

In the production method (b), first, the photosensitive material (b) having a support and a silver salt-containing layer is subjected to pattern exposure in a mesh-like pattern and subjected to a developing treatment to prepare an electrically conductive element precursor having a support and a developed silver mesh layer containing a mesh which includes developed silver. As for the pattern exposure, the same pattern exposure as the case of the production method (a) described above can be applied as it is. Further, as for the developing treatment including the fixing treatment and washing with water, the same developing treatment as the production method (a) described above can be applied as it is.

The electrically conductive element precursor thus obtained has a mesh layer including developed silver on a surface of one side of a transparent support.

(Formation of Electrically Conductive Microparticle-Containing Layer)

Next, an electrically conductive microparticle-containing layer is formed on the silver mesh layer of the electrically conductive element precursor.

For the electrically conductive microparticles and binder used in the electrically conductive microparticle-containing layer, the same electrically conductive microparticles and binder as those used in the above-described electrically conductive microparticle-containng layer of the electrically conductive element of the present invention can be used.

The electrically conductive microparticle-containing layer contains needle-like electrically conductive microparticles, a binder, and a sucrose fatty acid ester.

In this way, the electrically conductive element of the present invention, which has, on a transparent support, an electrically conductive layer including a silver mesh layer and an electrically conductive microparticle-containing layer, is produced.

(Other Processes Performed as Desired)

In the production method (b) of an electrically conductive element, after the preparation of an electrically conductive element precursor, but before the formation of an electrically conductive microparticle-containing layer, the electrically conductive element precursor may be subjected to an oxidization treatment, a reduction treatment, a smoothing treatment, a hot water treatment or a vapor treatment, a plating treatment, or the like, which are explained below.

(Oxidization Treatment)

The developed silver after the developing treatment is preferably subjected to an oxidization treatment. For example, in a case in which silver is slightly deposited on the light-transmitting portion, this silver can be removed by performing an oxidization treatment to attain a transmittance at the light-transmitting portion of approximately 100%.

Examples of the oxidization treatment include known methods using various oxidizing agents, for example, a Fe (III) ion treatment or the like. The oxidization treatment is performed after the developing treatment.

The developed silver after the pattern exposure and the developing treatment can be further treated with a solution containing Pd. Pd may be either a divalent palladium ion or a metal palladium. This treatment can suppress the black color of developed silver from variation with time.

In the production method of the present invention, a mesh which includes developed silver and in which the line width, the opening ratio, and the silver content are specified is directly formed on the support by the exposure and developing treatment, so that it has a sufficient surface resistivity, and therefore, it is unnecessary to perform a physical treatment and/or a plating treatment to the developed silver that constitutes the mesh, in order to impart anew conductivity thereto. Accordingly, a light-transmitting electrically conductive element can be produced by a simple process.

(Reduction Treatment)

In order to remove silver oxide and silver sulfide, which are impurities produced during the developing treatment, it is preferable to perform water washing treatment and to dip an electrically conductive element in an aqueous reducing solution after the developing treatment. In this way, the electrically conductive element having a much higher electrical conductivity may be obtained.

As the aqueous reducing solution, an aqueous solution of sodium sulfite, an aqueous solution of hydroquinone, an aqueous solution of p-phenylenediamine, an aqueous solution of oxalic acid, or the like can be used, wherein the aqueous solutions are more preferably adjusted to the pH of 10 or more.

(Smoothing Treatment)

The electrically conductive element precursor is preferably subjected to a smoothing treatment. By performing the smoothing treatment, the electric conductivity of the mesh which includes developed silver is significantly increased. The smoothing treatment is preferably performed by passing the electrically conductive element precursor 20 between a nip formed by at least a pair of rolls, which is constituted in a combination in which a first calender roll and a second calender roll are arranged to face each other such that the rotation axes of each roll are parallel, at a line pressure of 2940 N/cm or more. Hereinafter, the smoothing treatment using a calender roll is described as “a calender treatment”.

Examples of the rolls used for the first calender roll and the second calender roll include a resin roll, in which the material that constitutes at least the surface thereof is composed of a resin such as epoxy, polyimide, polyamide, polyimideamide, or the like, and a metal roll whose surface is composed of a metal. In particular, in the case of an electrically conductive element precursor prepared from a photosensitive material for forming an electrically conductive element which has a photosensitive layer on one sided surface of a support, it is preferable to perform the calender treatment according to the following conditions, in order to suppress the occurrence of wrinkles

(1) The thickness of the electrically conductive element precursor after the completion of the developing treatment is 95 μm or more.

(2) The calender treatment is performed by pressing the electrically conductive element precursor using a first calender roll and a second calender roll which are arranged to face each other.

(3) The first calender roll which contacts with the support is a resin roll.

More preferable conditions are as follows. It is enough that at least one of them is satisfied.

(a) The second calender roll which contacts with the mesh of the electrically conductive element precursor is a metal roll.

(b) The metal roll has a mirror-finished surface.

(c) The metal roll has an embossed surface.

(d) The surface roughness of the embossed metal roll is from 0.05 s to 0.8 s in maximum height, Rmax.

(e) The mesh has a volume ratio of silver/binder of 1/1 or more.

(f) The calender treatment is performed for the electrically conductive element precursor such that the line pressure between nips is from 2940 N/cm to 5880 N/cm.

(g) The calender treatment is performed at a conveyance speed of the electrically conductive element precursor of from 10 m/min to 50 m/min.

(h) When R1 represents a surface resistivity of the electrically conductive element precursor and R2 represents a surface resistivity of the electrically conductive element, R1 and R2 satisfy the following equation.

0.58≦R2/R1≦0.77

The temperature applied to the calender treatment is preferably from 10° C. (no temperature control) to 100° C., and more preferably in a range of from about 10° C. (no temperature control) to about 50° C., although it varies depending on the form of the mesh pattern, the area ratio of the mesh and the opening region or the forms thereof, and the kind of binder.

(Hot Water Treatment or Vapor Treatment)

After the formation of the silver mesh layer including developed silver on a transparent support, but before the formation of an electrically conductive microparticle-containing layer, it is preferable to perform a hot water treatment of immersing the electrically conductive element precursor into hot water or heated water having a temperature equal to or higher than the temperature of hot water, or a vapor treatment of contacting with vapor. In this way, the electrical conductivity and transparency can be improved more simply and easily in a short time. It is thought that a part of the water-soluble binder is removed and as a result, the number of bonding sites between developed silvers (the electrically conductive substances) is increased.

This process can be carried out after the developing treatment, but it is preferable to carry out after the smoothing treatment.

The temperature of the hot water used in the hot water treatment is preferably from 60° C. to 100° C. and more preferably from 80° C. to 100° C. Further, the temperature of the vapor used in the vapor treatment is preferably from 100° C. to 140° C. at 1 atm. The treating time of the hot water treatment or the vapor treatment depends on the type of water-soluble binder used, but in a case in which the size of the support is 60 cm×1 m, the treating time is preferably from about 10 seconds to about 5 minutes, and more preferably from about 1 minute to about 5 minutes.

(Plating Treatment)

An early stage or a subsequent stage of the smoothing treatment described above, the mesh may be subjected to a plating treatment. By the plating treatment, the surface resistivity can be further reduced, and the electrical conductivity can be enhanced. When the plating treatment is performed at the subsequent stage of the soothing treatment, the plating treatment may be performed efficiently, and a homogeneous plated layer may be formed. The plating treatment may be either electroplating or electroless plating. Further, the constituent materials of the plated layer preferable include a metal that has sufficient electrical conductivity, which is preferably copper.

The electrically conductive element of the first embodiment of the present invention, that is, the electrically conductive element having a metal pattern layer including an electrically conductive metal, and an electrically conductive microparticle-containing layer which contains needle-like electrically conductive microparticles having an average long axis length of from 0.2 μm to 20 μm, an average short axis length of from 0.01 μm to 0.02 μm, and an aspect ratio of 20 or more, a binder, and a sucrose fatty acid ester, is described above in detail. Also in the electrically conductive element of the second embodiment of the present invention, the electrically conductive element having a support and an electrically conductive microparticle-containing layer which contains needle-like electrically conductive microparticles, a binder, and a sucrose fatty acid ester, the same support and the same electrically conductive microparticle-containing layer as explained in the first embodiment can be employed.

According to the present invention, an electrically conductive element having a high electrical conductivity; a photosensitive material for forming an electrically conductive element, that is capable of producing an electrically conductive element having a high electrical conductivity; and a production method, with which a high electrically conductive element can be obtained, are provided. It is preferable to prepare an electrode having a metal pattern layer including an electrically conductive metal, an electrically conductive microparticle-containing layer which contains needle-shaped electrically conductive microparticles, a binder, and a sucrose fatty acid ester, and an electric current-passing layer disposed adjacent to the electrically conductive microparticle-containing layer, by using the foregoing electrically conductive element. Since the electrically conductive element of the present invention has a high electrical conductivity, even if the element is used as an electrode structure for a touch panel, an inorganic EL element, an organic EL element, or a solar cell, the visibility of the picture plane and the light permeability are not deteriorated at all. Further, since the electrically conductive element of the present invention also functions as a heat-generating sheet that generates heat when an electric current flows through the sheet, the electrically conductive element of the present invention can be used as an electrode structure for a defroster (a device for removing frost) of vehicles, window glass, or the like. Furthermore, with regard to the photosensitive material for forming an electrically conductive element according to the present invention, the photosensitive material with a large area can be produced easily, and therefore, it becomes possible to apply the photosensitive material of the present invention to an application field where electrically conductive elements with a large area are needed, for example, an electrode of an electro chromic device which is used for obtaining a window having a light control function of reducing a luminance of incident light or blocking incident light.

<EL Element>

Hereinafter, an example that applies the electrode structure of the present invention to an EL element is described in detail.

The EL element according to the present invention has a configuration in which a fluorescent substance layer is sandwiched between a pair of electrodes which face each other, wherein at least one of the pair of electrodes has the above electrically conductive element. The EL element may be either an organic EL element or an inorganic EL element.

The inorganic EL element that is a preferable exemplary embodiment of the present invention has a transparent electrode (the above electrically conductive element), a fluorescent substance layer, a reflective insulating layer, and a rear electrode in this order, and has the fluorescent substance layer at the side of the electrically conductive microprticle-containing layer of the electrically conductive element. The transparent electrode and the rear electrode are electrically connected through an electrode. A silver paste as an auxiliary electrode is applied to the electrode that contacts with the transparent electrode, and an insulating paste is applied to the side of the fluorescent substance layer.

It is possible to print and provide the fluorescent substance layer, the reflective insulating layer and the rear electrode on the transparent electrode, or to stick them together to form an element. Here, the expression “print and provide” refers to providing the fluorescent substance layer, the reflective insulating layer, and the rear electrode on the transparent electrode by printing directly. The expression “stick together” refers to thermally compressing the transparent electrode with a combination of the fluorescent substance layer, the reflective insulating layer and the rear electrode, to form an element.

When voltage is applied to the transparent electrode and the rear electrode, potential difference is applied to the fluorescent substance in the fluorescent substance layer. The potential difference becomes a light-emitting energy, and by successively applying the potential difference using an alternating current power supply, the light-emitting state is maintained. In this example, the fluorescent substance layer acts as an electric current-passing layer.

[Transparent Electrode]

In the transparent electrode in the present invention, the electrically conductive microparticle-containing layer of the above electrically conductive element is used in contact with the fluorescent substance layer.

[Fluorescent Substance Layer]

The fluorescent substance layer (fluorescent substance particle layer) is formed by dispersing fluorescent substance particles in a binder. Examples of the binder, which can be used, include a polymer having relatively high dielectric constant, such as a cyanoethyl cellulose resin, and resins, such as polyethylene, polypropylene, a polystyrene resin, a silicone resin, an epoxy resin, or polyvinylidene fluoride. The thickness of the fluorescent substance layer is preferably from 1 μm to 50 μm.

Specifically, the mother material of the fluorescent substance particles contained in the fluorescent substance layer includes microparticles of a semiconductor composed of at least one element selected from the group consisting of elements belonging to Group II and Group IV, and at least one element selected from the group consisting of elements belonging to Group III and Group V. A combination of these elements may be arbitrarily selected depending on the necessary light-emitting wavelength region. For example, ZnS, CdS, CaS, or the like can be used preferably.

The fluorescent substance particles preferably have an average sphere-equivalent diameter of from 0.1 μm to 15 μm. The coefficient of variation in sphere-equivalent diameter is preferably 35% or less and more preferably from 5% to 25%. The average equivalent spherical diameter can be measured using LA-500 (trade name) manufactured by Horiba Ltd., which uses the laser light scattering system, Coulter Counter manufactured by Beckman Coulter, Inc., or the like.

[Reflective Insulating Layer]

The inorganic EL element of the present invention preferably has a reflective insulating layer (hereinafter, may be referred to as “a dielectric substance layer” in some cases) between the fluorescent substance layer and the rear electrode.

In the dielectric substance layer, any material may be used as long as the material has a high dielectric constant and high insulating properties, and also has a high dielectric breakdown voltage. The material is selected from metal oxides and metal nitrides and, for example, BaTiO₃, BaTa₂O₆, or the like is used. The dielectric substance layer containing a dielectric substance may be provided at one side of the fluorescent substance particle layer, or may be provided at the both sides of the fluorescent substance particle layer.

Film formation of the fluorescent substance layer and the dielectric substance layer is preferably performed by coating using a spin coating method, a dip coating method, a bar coating method, a spray coating method, or the like, or by screen printing or the like.

[Rear Electrode]

As for the rear electrode at the side from which light is not taken out, any material having electrical conductivity can be used. As long as the material has electrical conductivity, for example, a transparent electrode such as ITO (indium tin oxide) or an aluminum/carbon electrode may be used, and the electrically conductive element described above may be also used as the rear electrode.

[Sealing and Water Absorption]

The EL element according to the present invention preferably has an appropriate sealing material on the opposite side of the transparent electrically conductive membrane, and is preferably processed so as to exclude the influence of humidity or oxygen from the external environment. In a case in which the substrate itself of the element has a sufficient shielding property, a moisture- or oxygen-shielding sheet may be placed on the upper side of the element prepared, and the surroundings can be sealed using a hardening material such as EPDXY. Further, in order to prevent a plane-like element from curling, a shielding sheet (moisture-proof film) may be disposed on the two sides of the element. In a case in which the substrate of the element has moisture permeability, the shielding sheet should be disposed on both sides of the element.

[Voltage and Frequency]

Usually, powder type EL elements are driven by alternating current. Typically, powder type EL elements are driven by use of an alternating-current source with 100 V in voltage and from 50 Hz to 400 Hz in frequency.

The present invention can be appropriately used in combination with techniques described in the publications or pamphlets with reference to Japanese Patent Application Laid-open numbers and International Patent Application Laid-open numbers listed up below.

JP-A No. 2004-221564, JP-A No. 2004-221565, JP-A No. 2007-200922, JP-A No. 2006-352073, WO2006/001461, JP-A No. 2007-129205, JP-A No. 2007-235115, JP-A No. 2007-207987, JP-A No. 2006-012935, JP-A No. 2006-010795, JP-A No. 2006-228469, JP-A No. 2006-332459, JP-A No. 2007-207987, JP-A No. 2007-226215, WO2006/088059, JP-A No. 2006-261315, JP-A No. 2007-072171, JP-A No. 2007-102200, JP-A No. 2006-228473, JP-A No. 2006-269795, JP-A No. 2006-267635, WO2006/098333, JP-A No. 2006-324203, JP-A No. 2006-228478, JP-A No. 2006-228836, WO2006/098336, WO2006/098338, JP-A No. 2007-009326, JP-A No. 2006-336090, JP-A No. 2006-336099, JP-A No. 2006-348351, JP-A No. 2007-270321, JP-A No. 2007-270322, WO2006/098335, JP-A No. 2007-201378, JP-A No. 2007-335729, WO2006/098334, JP-A No. 2007-134439, JP-A No. 2007-149760, JP-A No. 2007-208133, JP-A No. 2007-178915, JP-A No. 2007-334325, JP-A No. 2007-310091, JP-A No. 2007-116137, JP-A No. 2007-088219, JP-A No. 2007-207883, JP-A No. 2007-013130, WO2007/001008, JP-A No. 2005-302508, JP-A No. 2008-218784, JP-A No. 2008-227350, JP-A No. 2008-227351, JP-A No. 2008-244067, JP-A No. 2008-267814, JP-A No. 2008-270405, JP-A No. 2008-277675, JP-A No. 2008-277676, JP-A No. 2008-282840, JP-A No. 2008-283029, JP-A No. 2008-288305, JP-A No. 2008-288419, JP-A No. 2008-300720, JP-A No. 2008-300721, JP-A No. 2009-4213, JP-A No. 2009-10001, JP-A No. 2009-16526, JP-A No. 2009-21334, JP-A No. 2009-26933, JP-A No. 2008-147507, JP-A No. 2008-159770, JP-A No. 2008-159771, JP-A No. 2008-171568, JP-A No. 2008-198388, JP-A No. 2008-218096, JP-A No. 2008-218264, JP-A No. 2008-224916, JP-A No. 2008-235224, JP-A No. 2008-235467, JP-A No. 2008-241987, JP-A No. 2008-251274, JP-A No. 2008-251275, JP-A No. 2008-252046, JP-A No. 2008-277428, and JP-A No. 2009-21153.

### EXAMPLES

The present invention will be further described below in detail based on the examples, but it should be construed that the invention is in no way limited thereto. Note that, the term “%” means “% by mass”, unless indicated differently.

### Example 1

### Preparation of Emulsion A (Volume Ratio of Silver/Binder:1/1)

Liquid 1:

| | | |
|---|---|---|
| Water | 750 | mL |
| Phthalation-treated gelatin | 20 | g |
| Sodium chloride | 3 | g |
| 1,3-Dimethylimidazolidine-2-thione | 20 | mg |
| Sodium benzenethiosulfonate | 10 | mg |
| Critic acid | 0.7 | g |

Liquid 2

| | |
|---|---|
| Water | 300 mL |
| Silver nitrate | 150 g |

Liquid 3

| | | |
|---|---|---|
| Water | 300 | mL |
| Sodium chloride | 38 | g |
| Potassium bromide | 32 | g |
| Potassium hexachloroiridate(III) | 5 | mL |
| (0.005% KCl 20% aqueous solution) | | |
| Ammonium hexachlororhodate | 7 | mL |
| (0.001% NaCl 20% aqueous solution) | | |

The potassium hexachloroiridate(III) (0.005% KCl 20% aqueous solution) and the ammonium hexachlororhodate (0.001% NaCl 20% aqueous solution) used in the liquid 3 were prepared by dissolving a powder of the former complex in a 20% aqueous solution of KCl and by dissolving a powder of the latter complex in a 20% aqueous solution of NaCl, respectively, and heating each of resulting solutions at 40° C. for 120 minutes.

To the liquid 1, which was kept at a temperature of 38° C. and a pH of 4.5, the liquid 2 and liquid 3 in the amounts each of which corresponds to 90% of the total amount of respective liquid were added simultaneously over 20 minutes while stirring, thereby forming nucleus grains of silver halide with a size of 0.16 μm. Subsequently, the following liquid 4 and liquid 5 were added over 8 minutes, and then the rests of the liquid 2 and the liquid 3 in the amounts each of which corresponds to 10% of the total amount of respective liquid were added thereto over 2 minutes, thereby making the silver halide grains grow larger up to a size of 0.21 μm. Furthermore, 0.15 g of potassium iodide was added thereto, followed by ripening for 5 minutes, to finish the formation of silver halide grains.

Liquid 4

| | |
|---|---|
| Water | 100 mL |
| Silver nitrate | 50 g |

Liquid 5

| | | |
|---|---|---|
| Water | 100 | mL |
| Sodium chloride | 13 | g |
| Potassium bromide | 11 | g |
| Potassium ferrocyanide | 5 | mg |

Thereafter, washing with water was performed by a flocculation method according to a conventional method. Specifically, the temperature was lowered to 35° C., and the pH was lowered using sulfuric acid until the silver halide was precipitated (the pH was in a range of 3.6±0.2). Then, about 3 L of the supernatant were removed (first water washing). Further, 3 L of distilled water were added to the mixture, and then sulfuric acid was added until the silver halide was precipitated. 3 L of the supernatant were removed again (second water washing). The same procedure as the second water washing was further repeated once (third water washing), and thus, the water washing and desalting process was completed. The emulsion after the water washing and desalting process was adjusted to the conditions of pH of 6.4 and pAg of 7.5, and then 100 mg of 1,3,3a,7-tetrazaindene as a stabilizing agent and 100 mg of PROXEL (trade name, manufactured by ICI Co., Ltd.) as an antiseptic were added thereto. Finally, a silver iodochlorobromide cubic grain emulsion containing 70 mol % of silver chloride and 0.08 mol % of silver iodide, and having an average grain diameter of 0.22 μm and a coefficient of variation of 9% was obtained. The physical properties of the final emulsion were as follows: pH=6.4, pAg=7.5, electrical conductivity=4000 μS/cm, density=1.4×10³ kg/m³, and viscosity=20 mPa·s.

Preparation of Coating Liquid A

To the above emulsion, 8.0×10⁻⁴ mol/mol Ag of the following compound (Cpd-1) and 1.2×10⁻⁴ mol/mol Ag of 1,3,3a,7-tetrazaindene were added and mixed well. Subsequently, in order to adjust the swelling ratio, as necessary, the following compound (Cpd-2) was added thereto, and the pH of the coating liquid was adjusted to 5.6 using citric acid.

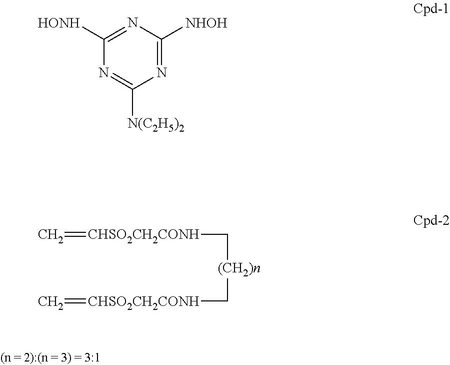

### Preparation of Emulsion B (Volume Ratio of Silver/Binder:4/1)

Liquid 1:

| | | |
|---|---|---|
| Water | 750 | mL |
| Gelatin (phthalation-treated gelatin) | 8 | g |
| Sodium chloride | 3 | g |
| 1,3-Dimethylimidazolidine-2-thione | 20 | mg |
| Sodium benzenethiosulfonate | 10 | mg |
| Critic acid | 0.7 | g |

Liquid 2

| | |
|---|---|
| Water | 300 mL |
| Silver nitrate | 150 g |

Liquid 3

| | | |
|---|---|---|
| Water | 300 | mL |
| Sodium chloride | 38 | g |
| Potassium bromide | 32 | g |
| Potassium hexachloroiridate(III) | 5 | mL |
| (0.005% KCl 20% aqueous solution) | | |
| Ammonium hexachlororhodate | 7 | mL |
| (0.001% NaCl 20% aqueous solution) | | |

The potassium hexachloroiridate(III) (0.005% KCl 20% aqueous solution) and the ammonium hexachlororhodate (0.001% NaCl 20% aqueous solution) used in the liquid 3 were prepared by dissolving a powder of the former complex in a 20% aqueous solution of KCl and by dissolving a powder of the latter complex in a 20% aqueous solution of NaCl, respectively, and heating each of the resulting solutions at 40° C. for 120 minutes.

To the liquid 1, which was kept at a temperature of 38° C. and a pH of 4.5, the liquid 2 and liquid 3 in the amounts each of which corresponds to 90% of the respective total liquid amount were added simultaneously over 20 minutes, while stirring, thereby forming nucleus grains of silver halide with a size of 0.16 μm. Subsequently, the following liquid 4 and liquid 5 were added over 8 minutes, and then the rests of the liquid 2 and liquid 3 in the amounts each of which corresponds to 10% of the respective total liquid amounts were added thereto over 2 minutes, thereby making the silver halide grains grow larger up to a size of 0.21 μm. Furthermore, 0.15 g of potassium iodide was added thereto, followed by ripening for 5 minutes, to finish the formation of silver halide grains.

Liquid 4

| | |
|---|---|
| Water | 100 mL |
| Silver nitrate | 50 g |

Liquid 5

| | | |
|---|---|---|
| Water | 100 | mL |
| Sodium chloride | 13 | g |
| Potassium bromide | 11 | g |
| Potassium ferrocyanide | 5 | mg |

Thereafter, washing with water was performed by a flocculation method according to a conventional method. Specifically, the temperature was lowered to 35° C., and the pH was lowered using sulfuric acid until the silver halide was precipitated (the pH was in a range of 3.6±0.2).

Then, about 3 L of the supernatant were removed (first water washing). Further, 3 L of distilled water were added to the mixture, and thereafter, sulfuric acid was added until the silver halide was precipitated. Then, 3 L of the supernatant were removed again (second water washing). The same procedure as the second water washing was further repeated once (third water washing), and thus, the water washing and desalting process was completed.

The emulsion after the water washing and desalting process was adjusted to the conditions of pH of 6.4 and pAg of 7.5, and then 10 mg of sodium benzenethiosulfonate, 3 mg of sodium benzenethiosulfinate, 15 mg of sodium thiosulfate, and 10 mg of chloroaurate were added thereto to carry out chemical sensitization at 55° C. such that optimal sensitivity was obtained, and then 100 mg of 1,3,3a,7-tetrazaindene as a stabilizing agent and 100 mg of PROXEL (trade name, manufactured by ICI Co., Ltd.) as an antiseptic were added thereto. Finally, a silver iodochlorobromide cubic grain emulsion containing 70 mol % of silver chloride and 0.08 mol % of silver iodide, and having an average grain diameter of 0.22 μm and a coefficient of variation of 9% was obtained. The physical properties of the final emulsion were as follows: pH=6.4, pAg=7.5, electrical conductivity=40 μS/m, density=1.2×10³ kg/m³, and viscosity=60 mPa·s.

<<Preparation of Coating Liquid B>>

To the above emulsion B, 5.7×10⁻⁴ mol/mol Ag of sensitizing dye (SD-1) were added to carry out spectral sensitization. Further, 3.4×10⁻⁴ mol/mol Ag of KBr and 8.0×10⁻⁴ mol/mol Ag of compound (Cpd-3) were added thereto and mixed well.

Subsequently, 1.2×10⁻⁴ mol/mol Ag of 1,3,3a,7-tetrazaindene, 1.2×10⁻² mol/mol Ag of hydroquinone, 3.0×10⁻⁴ mol/mol Ag of citric acid, 90 mg/m² of sodium 2,4-dichloro-6-hydroxy-1,3,5-triazine, 15% of colloidal silica having a particle diameter of 10 μm relative to the amount of gelatin, 50 mg/m² of aqueous latex (aqL-6), 100 mg/m² of polyethyl acrylate latex, 100 mg/m² of a latex copolymer obtained from, as polymer components, methyl acrylate, sodium 2-acrylamido-2-methylpropanesulfonate, and 2-acetoxyethyl methacrylate (mass ratio 88:5:7), 100 mg/m² of a core-shell type latex [core: a styrene/butadiene copolymer mass ratio 37/63), shell: styrene/2-acetoxyethyl acrylate (mass ratio 84/16, core/shell ratio=50/50)], and 4% of the following compound (Cpd-7) relative to the amount of gelatin were added thereto, and the pH of the coating liquid was adjusted to 5.6 using citric acid.

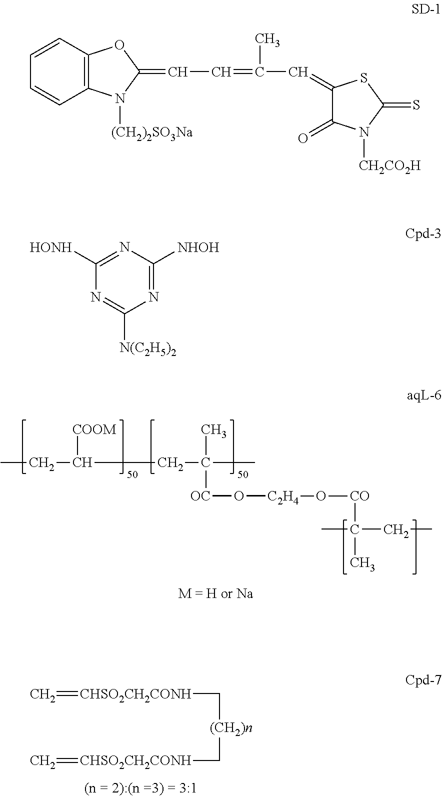

(Silver Halide Emulsion Layer (Silver Salt-Containing Layer))

The emulsion layer coating liquid A prepared by using the emulsion A as described above was coated to provide a layer such that the volume ratio of silver/binder (silver/GEL ratio (by volume)) was 1.03/1, the amount of Ag was 8.0 g/m², and the amount of gelatin was 0.99 g/m².

Using the emulsion B, a layer was provided such that the volume ratio of silver/binder (silver/GEL ratio (by volume)) was 4.0/1, the amount of Ag was 10.0 g/m², and the amount of gelatin was 0.32 g/m².

(As the support, polyethylene terephthalate (PET) (having a thickness of 100 μm) was used. The PET was subjected to a surface hydrophilization treatment in advance, and then used.)

(Electrically Conductive Microparticle-Containing Layer)

An electrically conductive microparticle-containing layer was provided by coating the following electrically conductive microparticle liquid 1 in an amount of 10 cc/m² on the upper part of the above-described silver halide emulsion layer in a manner as described below.

Liquid 1:

| | | |
|---|---|---|
| Water | 943 | mL |
| Gelatin | 10 | g |
| Sb-doped tin oxide (trade name: FS10D, manufactured by | 48.4 | g |
| Ishihara Sangyo Kaisha, Ltd.; needle-like electrically | | |
| conductive microparticles) | | |
| Sucrose fatty acid ester (manufactured by Wako Pure | 9.6 | g |
| Chemical Industries, Ltd.; sucrose monolaurate) | | |

In addition, an antiseptic and a pH adjusting agent were appropriately added thereto. The sucrose fatty acid ester functions as a surfactant, and suppresses the aggregation of electrically conductive microparticles. Here, according to a catalog, FS10D (trade name) manufactured by Ishihara Sangyo Kaisha, Ltd. has an average long axis length of from 0.2 μm to 2.0 μm, an average short axis length of from 0.01 μm to 0.02 μm, and an aspect ratio of from 20 to 30.

A coated substance was prepared using the emulsion layer coating liquid A for providing the silver halide emulsion layer, and using the electrically conductive microparticle liquid 1 for providing the layer containing electrically conductive microparticles. A product obtained by drying the coated substance is designated as photosensitive material 5.

In photosensitive material 5, the electrically conductive microparticles are coated such that the amount of electrically conductive microparticles is 0.46 g/m² and the electrically conductive microparticles/binder ratio is 4.84/1 (by mass ratio) in the protective layer. In order to find out resistance of the electrically conductive microparticles alone (electrically conductive membrane resistance), this photosensitive material A was not subjected to both exposing and a developing treatment, but only subjected to a fixing treatment to remove the silver halide, followed by measurement of surface resistance, and as a result, the surface resistance was found to be 10⁷Ω/□. The surface resistance (Ω/□) was measured using a digital ultrahigh resistance/minute-current ammeter 8340A (trade name, manufactured by ADC Corporation).

<Coating Method>

On the support provided with an undercoat layer, two layers of a silver halide emulsion layer and an electrically conductive microparticle-containing layer were subjected to simultaneous multilayer coating, while maintaining at 35° C., in this order from the side nearer to the support on the emulsion face side, by a slide bead coater system, while adding a hardening agent liquid, and thereafter, the resulting coated material was passed through a cold wind setting zone (5° C.), which was then passed through another cold wind setting zone (5° C.). At the time when the coated material was passed through each of the setting zones, the coating liquids exhibited sufficient setting properties. Subsequently, the two sides of the coated material were simultaneously dried at a drying zone.

It should be noted that a protective layer containing silica may be provided on the electrically conductive microparticle-containing layer, and further coating of the protective layer may be carried out using a known coating method.

Preparation of photosensitive materials 1 to 4 and 6 to 8 was conducted in the same manner as the preparation of photosensitive material 5, except that the amount of the sucrose fatty acid ester contained in the electrically conductive microparticle-containing layer of the photosensitive material 5 was changed. In these photosensitive materials, the addition amounts of the sucrose fatty acid ester were changed such that the coating amounts of the sucrose fatty acid ester were 0 g/m², 0.01 g/m², 0.05 g/m², 0.07 g/m², 0.12 g/m², 0.14 g/m², and 0.19 g/m², respectively, without changing both the electrically conductive microparticles/binder ratio and the coating amount of the electrically conductive microparticles. Further, as the comparative examples, photosensitive materials 10 to 19 were obtained by changing the sucrose fatty acid ester in the electrically conductive microparticle-containing layer to the surfactant shown in Table 1. The details of changes on each photosensitive material (sample) are shown in Table 1.

(Evaluation)

With regard to each of the samples, the frequency of occurrence of aggregation of needle-like electrically conductive microparticles per an area of 30 cm×30 cm was examined. It was found that, in the sample in which the sucrose fatty acid ester was not added, the occurrence of aggregation was remarkable, but by the inclusion of the sucrose fatty acid ester, the above-described aggregation can be suppressed. Further, it was found that, when the content of the sucrose fatty acid ester exceeds a certain amount, the surface resistivity began to decrease. From these results, it was found that the photosensitive material 5 is able to achieve the best balance between suppression of aggregation and surface resistivity. Further, it was revealed by emission of light from an inorganic EL element prepared using the obtained sample that in a case in which aggregation occurred at the light-emitting part, the point corresponding to the aggregation became a defect, which resulted in non-light emitting. The number of the non-light-emitting part was counted to evaluate it as the number of defect. Note that, the exposure and developing treatment of the photosensitive materials and the preparation of the inorganic EL elements were conducted in the same manner as Example 2 described below. The obtained results are shown in Table 1.

TABLE 1

| | | | Coating Amount of | | | | |
|---|---|---|---|---|---|---|---|
| | | | Electrically | Coating | Content Ratio of | Number of | |
| | Mesh | | Conductive | Amount of | Surfactant/Electrically | Defect | |
| | Resistivity | | Microparticles | Surfactant | Conductive | (30 cm × | |
| Sample | (Ω/□) | Surfactant | (g/m²) | (g/m²) | Microparticles | 30 cm) | |
| 1 | 30 | None | 0.47 | 0.00 | 0% | 32 | Comparative |
| | | | | | | | Example |
| 2 | 30 | Sucrose monolaurate | 0.47 | 0.01 | 2% | 22 | Example |
| 3 | 30 | | 0.47 | 0.05 | 10% | 10 | Example |
| 4 | 30 | | 0.47 | 0.07 | 15% | 0 | Example |
| 5 | 30 | | 0.47 | 0.09 | 20% | 0 | Example |
| 6 | 30 | | 0.47 | 0.12 | 25% | 0 | Example |
| 7 | 30 | | 0.47 | 0.14 | 30% | 0 | Example |
| 8 | 30 | | 0.47 | 0.19 | 40% | 0 | Example |
| 10 | 30 | Sodium-bis(3,3,4,4,5,5,6,6,6- | 0.47 | 0.09 | 20% | 34 | Comparative |
| | | nonafluorohexyl)-2-(sulfinatooxy)succinate | | | | | Example |
| 11 | 30 | α-Perfluorononenyloxy-ω-methyl- | 0.47 | 0.09 | 20% | 38 | Comparative |
| | | polyethylene oxide | | | | | example |
| 12 | 30 | N,N-Dimethyl-3-[(1-oxododecyl)amino]- | 0.47 | 0.09 | 20% | 32 | Comparative |
| | | propyl ammonium acetate | | | | | Example |
| 13 | 30 | Polyoxyethylene nonyl phenyl ether | 0.47 | 0.09 | 20% | 31 | Comparative |
| | | | | | | | Example |
| 14 | 30 | Sodium olefin sulfonate | 0.47 | 0.09 | 20% | 29 | Comparative |
| | | | | | | | Example |
| 15 | 30 | Sodium 1,2-di(hexyloxycarbonyl)ethane | 0.47 | 0.09 | 20% | 35 | Comparative |
| | | sulfonate | | | | | example |
| 16 | 30 | Sodium N-oleyl-N-methyl taurate | 0.47 | 0.09 | 20% | 34 | Comparative |
| | | | | | | | Example |
| 17 | 30 | Sodium dioctylsulfosuccinate | 0.47 | 0.09 | 20% | 36 | Comparative |
| | | | | | | | Example |
| 18 | 30 | Sodium-bis(3,3,4,4,5,5,6,6,6-nonafluoro- | 0.47 | 0.09 | 20% | 31 | Comparative |
| | | hexyl)-2-(sulfinatooxy)methyl succinate | | | | | example |
| 19 | 30 | Sodium 4-[2-[2-(2-decyloxy-ethoxy)- | 0.47 | 0.09 | 20% | 31 | Comparative |
| | | ethoxy]-ethoxy]-butane-1-sulfonate | | | | | Example |

Among the surfactants described above,

As the α-perfluorononenyloxy-w-methyl-polyethylene oxide, FTERGENT 215M (trade name) manufactured by NEOS COMPANY LIMITED was used,

As the polyoxyethylene nonyl phenyl ether, EMALEX NP-30 (trade name) manufactured by Nihon Emulsion Co., Ltd. was used,

As the sodium olefin sulfonate, F-14 (trade name) manufactured by Lion Corporation was used, and

As the sodium dioctylsulfosuccinate, RAPISOL B-90 (trade name) manufactured by NOF Corporation was used.

As the surfactants other than the above surfactants, internally synthesized compounds were used.

The evaluation results of the above samples are as follows. Aggregation occurred in Sample 1 which did not contain the sucrose fatty acid ester, and therefore, a lot of defects were observed in the EL element, but by adding the sucrose fatty acid ester thereto, the aggregation was suppressed, and defects were hardly observed in the EL element. In a case in which the content of the sucrose fatty acid ester is 0.07 g/m² or more, preferably 0.09 g/m² or more, aggregation does not occur. Furthermore, in a case in which sucrose monostearate was used in place of the sucrose monolaurate in Sample 5, the same effect as those achieved by Sample 5 was confirmed.

### Example 2

Evaluation of durability was performed by changing the electrically conductive microparticle-containing layer in photosensitive material 5 to the following.

(Electrically Conductive Microparticle-Containing Layer)

An electrically conductive microparticle-containing layer was provided on the upper part of the silver halide emulsion layer by coating the following electrically conductive microparticle liquid 2 in an amount of 5 cc/m².

Liquid 2:

| | | |
|---|---|---|
| Water | 943 | mL |
| Gelatin | 10 | g |
| Sb-doped tin oxide (trade name: SN100P, manufactured by | 24.2 | g |
| Ishihara Sangyo Kaisha, Ltd.; granular electrically conductive | | |
| microparticles) | | |
| Sucrose fatty acid ester (manufactured by Wako Pure | 9.6 | g |
| Chemical Industries, Ltd.; sucrose monolaurate) | | |

In addition, an antiseptic and a pH adjusting agent were appropriately added thereto. Here, according to a catalog, SN100P (trade name) manufactured by Ishihara Sangyo Kaisha, Ltd. is granular, and has a primary particle diameter of from 0.01 μm to 0.03 μm, and an aspect ratio of approximately 1.

A coated substance was prepared using the emulsion layer coating liquid A for providing the silver halide emulsion layer, and using the electrically conductive microparticle liquid 2 for providing the layer containing electrically conductive microparticles. A product obtained by drying the coated substance was designated as photosensitive material A.

In photosensitive material A, granular and electrically conductive microparticles are coated such that the amount of the electrically conductive microparticles is 0.23 g/m² and the electrically conductive microparticles/binder ratio is 4.84/1 (by mass ratio) in the protective layer. In order to find out resistance of the electrically conductive microparticles alone (electrically conductive membrane resistance), this photosensitive material A was not subjected to both exposure and a developing treatment, but only subjected to a fixing treatment to remove the silver halide, followed by measurement of surface resistance, and as a result, the surface resistance was found to be 10⁸Ω/□.

Photosensitive material 5 containing the needle-like electrically conductive microparticles, which was used in Example 1, was designated as photosensitive material B, which was compared with photosensitive material A containing granular electrically conductive microparticles (trade name: SN100P, manufactured by Ishihara Sangyo Kaisha, Ltd.).

(Exposure and Developing Treatment)

Photosensitive materials A and B were each exposed using a parallel light from a high pressure mercury lamp as a light source through a photomask having a lattice form photomask with a line/space of 595 μm/5 μm (pitch 600 μm), which is capable of giving a developed silver image having a line/space of 5 μm/595 μm, and spaces in a lattice form, then developed using the following developing solution and further fixed using a fixing solution (trade name: N3X-R for CN16X, manufactured by Fujifilm Corporation) to complete a developing treatment, and then rinsing with pure water, thereby obtaining Samples A and B.

[Composition of Developing Solution]

The following compounds are contained in 1 liter of the developing solution.

| | |
|---|---|
| Hydroquinone | 0.037 mol/L |
| N-Methylaminophenol | 0.016 mol/L |
| Sodium metaborate | 0.140 mol/L |
| Sodium hydroxide | 0.360 mol/L |
| Sodium bromide | 0.031 mol/L |
| Potassium metabisulfite | 0.187 mol/L |

(Preparation of Electroluminescence Element)

Samples A and B prepared as described above were each integrated into a powder-type inorganic EL (electroluminescence) element to make a light emission test.

A reflective insulating layer containing a pigment having an average particle diameter of 0.03 μm and a light emitting layer containing fluorescent substance particles having a size of from 50 μm to 60 μm were disposed by coating, on an aluminum sheet to act as a rear electrode, followed by drying at 110° C. for 1 hour using a hot air dryer.

Thereafter, Samples A and B were each placed on the surface of the fluorescent substance layer and the dielectric substance layer of the rear electrode, and the integrated members were thermally compressed to form an EL element. The element was sandwiched between two sheets of water-absorbing sheet made of nylon 6 and two sheets of moisture-proof film, and the integrated members were thermally compressed. The size of the EL element was 30 cm×30 cm.

As the power source to be used for emitting light, a constant-frequency constant-voltage power source CVFT-D SERIES (trade name, manufactured by Tokyo Seiden Co., Ltd.) was used. Further, for the measurement of luminance (cd/m²), a luminance meter BM-9 (trade name, manufactured by Topcon Technohouse Corp.) was used.

Using Samples A and B, powder-type inorganic EL (electroluminescence) elements were formed. As a durability test, the inorganic EL elements were controlled to emit light continuously at 100 V and 400 Hz, under the conditions of temperature of 60° C. and humidity of 90%, and the change in luminance after 240 hours was examined. The results are shown in the table. In Sample A in which granular electrically conductive microparticles were used, non-light-emitting parts were generated when light was emitted continuously, and the change in luminance was large; whereas in Sample B in which needle-like electrically conductive microparticles were used, non-light-emitting parts were not generated and the change in luminance was small. The reason for this is guessed that the needle-like electrically conductive microparticles are more likely to form a network as compared with the granular ones, and the network formation helps improvement in durability. The obtained results are shown in Table 2.

TABLE 2

| | | | | Coating Amount of | | | | | |
|---|---|---|---|---|---|---|---|---|---|
| | | | Kind of | Electrically | Coating | Ratio of | | | |
| | Mesh | | Electrically | Conductive | Amount of | Surfactant/Electrically | Change | Evaluation | |
| | Resistivity | | Conductive | Microparticles | Surfactant | Conductive | Ratio of | of | |
| Sample | (Ω/□) | Surfactant | Microparticles | (g/m²) | (g/m²) | Microparticles | Luminance | Durability | |
| A | 30 | Sucrose | Granular | 0.47 | 0.09 | 19% | 0.65 | Poor | Comparative |
| | | monolaurate | | | | | | | Example |
| B | 30 | | Needle-like | 0.47 | 0.09 | 19% | 0.02 | Good | Example |

It will be obvious that various changes in configuration may be made, without being limited to the above-described embodiments, unless the present invention departs from its purport.

The disclosure of Japanese Patent Application No. 2010-010276, filed on Jan. 20, 2010, is incorporated by reference herein in its entirety.

All publications, patent applications, and technical standards mentioned in this specification are herein incorporated by reference to the same extent as if such individual publication, patent application, or technical standard was specifically and individually indicated to be incorporated by reference.

1. An electrically conductive element comprising:
a support;
a metal pattern layer comprising an electrically conductive metal; and
an electrically conductive microparticle-containing layer comprising needle-shaped electrically conductive microparticles having an average long axis length of from 0.2 μm to 20 μm, an average short axis length of from 0.01 μm to 0.02 μm, and an aspect ratio of 20 or more, a binder, and a sucrose fatty acid ester.

2. The electrically conductive element according to claim 1, wherein a content ratio of the sucrose fatty acid ester to the needle-shaped electrically conductive microparticles is from 10% by mass to 50% by mass.

3. The electrically conductive element according to claim 1, wherein a content of the sucrose fatty acid ester contained in the electrically conductive microparticle-containing layer is 0.5 g/m² or less.

4. The electrically conductive element according to claim 1, wherein the electrically conductive microparticles comprise a metal oxide selected from the group consisting of SnO₂, ZnO, TiO₂, Al₂O₃, In₂O₃, MgO, BaO and MoO₃, a composite metal oxide thereof, and a metal oxide in which a different atom is incorporated into the metal oxide or the composite metal oxide.

5. The electrically conductive element according to claim 1, wherein the electrically conductive microparticles comprise SnO₂ doped with antimony.

6. The electrically conductive element according to claim 1, wherein a content of the electrically conductive microparticles contained in the electrically conductive microparticle-containing layer is from 0.05 g/m² to 0.99 g/m².

7. An electrically conductive element comprising a support and an electrically conductive microparticle-containing layer comprising needle-shaped electrically conductive microparticles, a binder and a sucrose fatty acid ester.

8. A photosensitive material for formation of an electrically conductive element, comprising: a support; a silver salt-containing layer; and an electrically conductive microparticle-containing layer comprising needle-shaped electrically conductive microparticles, a binder and a sucrose fatty acid ester.

9. An electrode comprising: a metal pattern layer comprising an electrically conductive metal; an electrically conductive microparticle-containing layer comprising needle-shaped electrically conductive microparticles, a binder, and a sucrose fatty acid ester; and an electric current-passing layer disposed adjacent to the electrically conductive microparticle-containing layer.

10. The electrically conductive element according to claim 3, wherein a content of the sucrose fatty acid ester contained in the electrically conductive microparticle-containing layer is from 0.01 g/m² to 0.5 g/m².

11. The electrically conductive element according to claim 3, wherein a content of the sucrose fatty acid ester contained in the electrically conductive microparticle-containing layer is from 0.01 g/m² to 0.19 g/m².

12. The electrically conductive element according to claim 1, wherein the sucrose fatty acid ester comprises sucrose monolaurate.

13. The electrically conductive element according to claim 2, wherein the sucrose fatty acid ester comprises sucrose monolaurate.

14. The electrically conductive element according to claim 2, wherein the electrically conductive microparticles comprise a metal oxide selected from the group consisting of SnO₂, ZnO, TiO₂, Al₂O₃, In₂O₃, MgO, BaO and MoO₃, a composite metal oxide thereof, and a metal oxide in which a different atom is incorporated into the metal oxide or the composite metal oxide.

15. The electrically conductive element according to claim 1, wherein the electrically conductive microparticles comprise SnO₂ doped with antimony, and the sucrose fatty acid ester comprises sucrose monolaurate.

16. The electrically conductive element according to claim 2, wherein the electrically conductive microparticles comprise SnO₂ doped with antimony, and the sucrose fatty acid ester comprises sucrose monolaurate.

17. The electrically conductive element according to claim 1, wherein the electrically conductive microparticles comprise SnO₂ doped with a content of from 0.2 to 2.0 mol % of antimony.

18. The electrically conductive element according to claim 2 wherein a content of the electrically conductive microparticles contained in the electrically conductive microparticle-containing layer is from 0.05 g/m² to 0.99 g/m².

19. The electrically conductive element according to claim 7, wherein a content ratio of the sucrose fatty acid ester to the needle-shaped electrically conductive microparticles is from 10% by mass to 50% by mass.

20. The electrically conductive element according to claim 7, wherein a content of the sucrose fatty acid ester contained in the electrically conductive microparticle-containing layer is from 0.01 g/m² to 0.5 g/m².
